(19) United States
(12) Patent Application Publication
(10) Pub. No.: US 2012/0084435 A1
(43) Pub. Date: Apr. 5, 2012

(54) Smart Real-time Content Delivery

(75) Inventors: Mitesh H. Vasa, Bangalore (IN); Vinod V. Mankar, Banglore (IN); Bhuvan Sharma, Bengaluru (IN)

(73) Assignee: International Business Machines Corporation, Armonk, NY (US)

(21) Appl. No.: 12/896,986

(22) Filed: Oct. 4, 2010

(51) Int. Cl. G06F 15/173

(52) U.S. Cl. 709/224

(57) ABSTRACT

A method, a computer program product, and a system is provided to monitor several continuously transmitted content channels, each providing video information and audio information, or a combination thereof with text information; simultaneously convert the monitored content from each channel to provide data stream feeds for each of these channels; simultaneously analyze each channel feed to determine if a user provided topic is included in any of these feeds; and send an alert to the user when a channel feed includes a user provided topic. In a further embodiment, the method includes delivery of content from the channel feed to a user device, upon request, in a user designated transmission format (such as video, audio or text).

### BACKGROUND OF THE INVENTION

1. Technical Field

The present invention relates to retrieving media content. In particular, the present invention relates to monitoring and retrieving content according to user defined topics.

2. Description of the Related Art

Today, there are numerous TV channels, radio stations and internet-based sources of information, all providing content continuously. People do not have the time and luxury to browse or surf the channels for topics of their interest. Further, with the number of information sources, there is a possibility of missing a program or an event completely while engrossed in browsing other channels or involved in other activities.

### SUMMARY

In accordance with the present invention, a method is provided for monitoring a plurality of continuously transmitted content channels, each providing video information and audio information, or a combination thereof with text information, simultaneously converting the monitored content from each channel to provide data stream feeds for each of these channels, simultaneously analyzing each channel feed to determine if a user provided topic is included in any of these feeds; and sending an alert to the user when a channel feed includes a user provided topic. In a further embodiment, the method includes delivery of content from the channel feed to a user device, upon request, in a user designated transmission format (such as video, audio or text).

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of smart real-time content delivery system;

FIG. 2 is a flowchart illustrating a user registration process;

FIG. 3 is a flowchart of the monitoring of the simultaneous transmissions of content on several channels to produce individual data feeds;

FIG. 4 is a flowchart of the analysis of the individual data feeds to determine if a user provided topic is being addressed;

FIG. 5 is a flowchart of the alert process and the ranking process if multiple alerts occur;

FIG. 6 is a flowchart of the process for providing content to the user if requested after receiving the alert.

### DETAILED DESCRIPTION

The following is intended to provide a detailed description of examples of the invention and should not be taken to be limiting of the invention itself. Rather, any number of variations may fall within the scope of the invention, which is defined in the claims following the description.

The present invention is a method for monitoring several continuously transmitted content channels, each providing video information and audio information, or a combination thereof with text information, simultaneously converting the monitored content from each channel to provide data stream feeds for each of these channels, simultaneously analyzing each channel feed to determine if a user provided topic is included in any of these feeds; and sending an alert to the user when a channel feed includes a user provided topic. In a further embodiment, the method includes delivery of content from the channel feed to a user device, upon request, in a user designated transmission format (such as video, audio or text).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction implementation system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction implementation system, apparatus, or device.

Program code embodied on a computer readable medium may be transmitted using any appropriate medium, including but not limited to wireless, wire line, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may be implemented entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which are implemented via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which are implemented on the computer or other programmable apparatus provide processes for implementing the functions/acts specified in the flowchart and/or block diagram block or blocks.

This invention provides an intelligent monitoring and alert system to provide an alert to a user upon the occurrence of previously provided user topics that have been addressed on monitored real-time continuously transmitted media channels such as television, radio, etc. In the embodiment presented, a user has previously registered with the system of this invention and has provided topics of interest along with designated media channels providing streaming audio, video and/or text information. Additionally the user may provide the number of results he or she wants to receive per alert, selected time slots for monitoring and a preferred format for transition of content to a user device such as a cell phone. For example, a user may be interested in news items about hurricane Katrina or George Bush. The user may specify broadcast sources such as CNN broadcast news or the Discovery Channel which might run a documentary on these topics. Typically the user would wish to be alerted first by a text message to a cell phone. If the user's cell phone or other device has a high bandwidth capability, the system could also provide a retransmission of the streamed information directly to the user's device. This would occur if the user has communicated this desire to the system. Significantly, the user can provide a textual topic which is provided as text data or more importantly a video topic or an image topic or an audio topic. The video and audio topics would be provided as video or audio segments. An image topic would be an image file. These topics are stored in a repository in memory and then matched against the real-time transmission of channel information which are extracted and stored in other buffers to determine if one of the user's topics is being addressed. This repository also stores alerts and user profiles in memory. Upon determining that a user topic is being addressed, an alert will be provided to the user. In the present embodiment, an alert provides the channel, the program and other topic information to a user. Also, in the present embodiment, a user can add, delete, or update topics at any time after user registration.

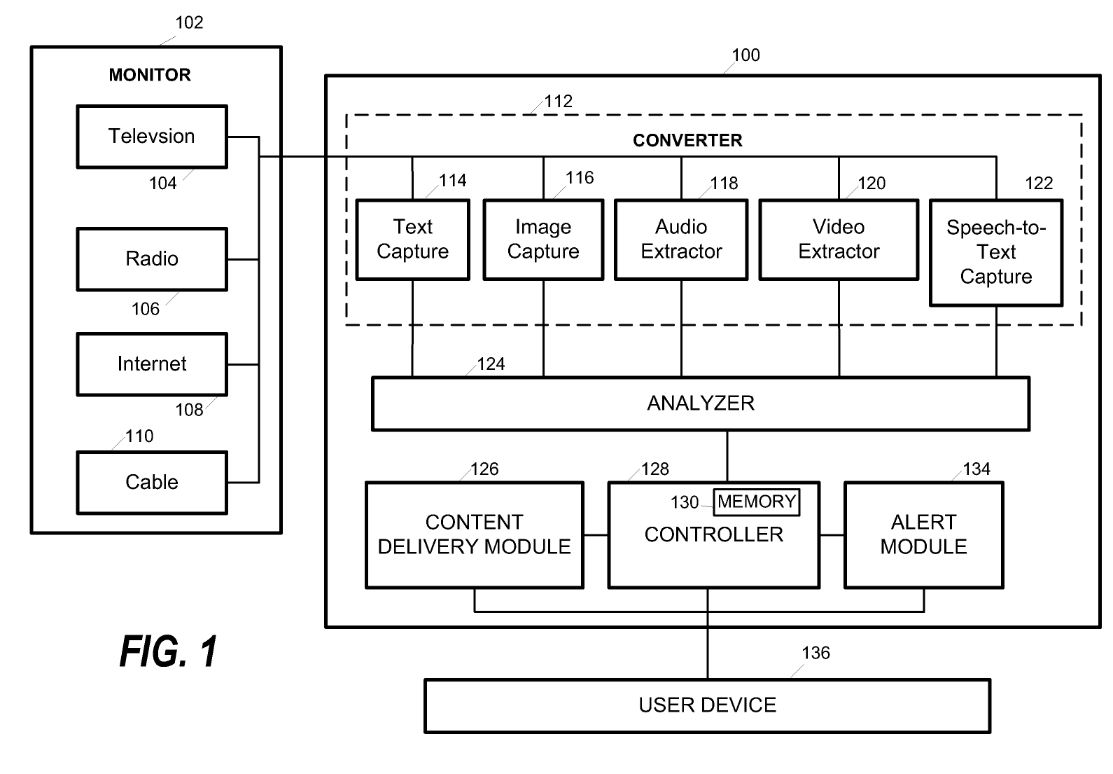

FIG. 1 is a block diagram of a preferred embodiment of the invention. In block 102, a monitoring function is performed where real-time continuously transmitted content channels are being monitored such as a television channel 104, a radio channel 106, an Internet web site 108, or a cable channel 110. It should be understood that these are just examples of individual channel types that may be monitored. This invention would be useful for monitoring other types of information that is provided in a streaming format. Each of these monitored channels are provided to a converter 112 contained in a content delivery block 100. The converter 112 includes a text capture function 114, an image capture function 116, an audio extractor function 118, a video extractor function 120, and a speech to text capture function 122. The text capture function 114 would extract close captioning information from television channels and provide this as a data feed. Closed captions provide subtitles for television broadcast and this invention uses such information to determine if a user topic is being addressed by that television broadcast. The image capture function 116 is simply capturing a still image file from any of the continuously transmitting content channels and also is capturing images generated as video frames from the video extractor 120. This image would be stored and compared to a user topic image previously stored to determine if it matches the user topic image. The audio extractor 118 captures the audio track of a content channel such as background music or a spoken voice portion of an audio video presentation on television or an audio presentation of a radio channel or cable continuously transmitted by the content channel. When captured, the audio portion is stored and later examined to determine if it matches a user topic audio segment. The video extractor 120 captures video frames from a video transmission. This can include Internet based video sources. An example of a current product that performs this function is the Fast Video Indexer. Video is extracted and stored in a buffer for later comparison to previously provided user topic video segments. The speech to text capture function 122 accesses an audio or video channel and converts any spoken language to text which is then stored in a text buffer for later analysis with previously provided user topic text. An example of a current product that provides speech-to-text conversion capabilities or speech recognition capabilities is Dragon NaturallySpeaking.

The analyzer 124 is connected to analyze captured text from the text capture function 114, a captured image from the image capture function 116, a captured audio segment from the audio extractor function 118, a video segment from the video extractor 120, or text from this speech-to-text capture function 122. The analyzer then determines if any of these captured media address predefined user topics. The analyzer is controlled and monitored by a controller 128 that is connected to a memory 130. In this preferred embodiment, the controller 128 is a computer-based system including application software contained in memory 130. This memory 130 includes the storage of programs, repositories and database of information used in this invention. Analyzer 124 and controller 128 provide a data mining function for each of the different media received from the converter 112. For instance, the data mining function would compare the captured text with the previously stored user topic text to determine if the user topic is being addressed. Programs that currently provide this text comparison capability are RapidMiner (http://rapid-i.com), and SPSS (http://www.spss.com/). Likewise the image mining function would compare the captured image with the stored user topic image. Existing image matching software includes CIRES (http://cires.matthewriley.com/) and Cortina (http://vision.ece.ucsb.edu/multimedia.cortina.shtml). Data mining of the extracted segments from the audio extractor function 118 is performed by comparing these audio segments with user topic audio segments. Current technology for this audio matching function includes SoundSpotter (http://soundspotter.org/). The video extractor function 120 will provide a captured video segment for comparison with the user topic video segment using a program such as Teemoon Video Matching (http://teemoon.name/videoid/html). Again, a video segment is a series of video frames where each frame represents a single image. The speech-to-text analysis function converts the speech/spoken audio component of the channel to text, which is then used to do a simple text to text comparison with the user provided topic text.

When the analyzer 124 determines that a user-defined topic is being addressed, the controller 128 can initiate the memory 130 to start storing the designated channel containing the user topic that has been addressed or matched. That way, the actual content that is being transmitted can be stored to be provided to a user device 136. Also, the controller 128 indicates to the alert module 134 that an alert is to be composed and transmitted to the user device 136. Upon user request, the content delivery module 126 would initiate a session with the user device 136 and start streaming the content in the user designated transmission format from the memory.

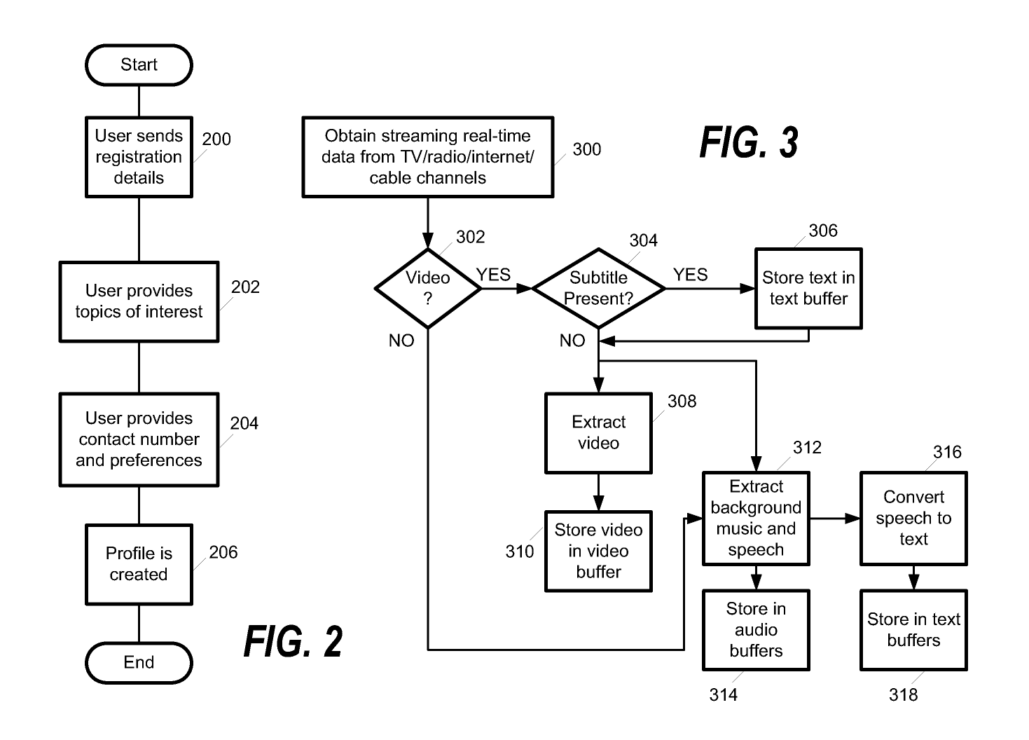

FIG. 2 is a flowchart that shows the simple user registration process where the user provides the topic of interest, the specific channels for monitoring, any times for monitoring, any language restrictions such as only English, a user contact number if a cell phone is being used as a user device, or other common user preference information. Referring to FIG. 2, in block 200 the user registers by sending the registration details. Typically, this would be done to an Internet web site that would record the registration information. In block 202, the user provides the topics of interest. As discussed previously, the topics of interest can include text, image, video segments, or an audio segment. In block 204, the user provides contact numbers and any other preference information. Then, in block 206, the profile is created.

FIG. 3 is a flowchart of the monitoring and extraction process. In block 300, each of the monitored real-time transmitting content channels are monitored and converted to media data streams. In block 302, a determination is made as to whether the data stream that is being provided is a video data stream. If so, in decision module 304, it is determined whether the video data stream includes subtitle information. If so, in block 306 the text from the subtitle information is stored in a text buffer. Returning to decision module 304, if no subtitle is present, the video data stream is provided to both block 308 and block 312. In block 308, the video is extracted and stored in a video buffer in block 310. In block 312, any music or speech contained on the video feed is extracted and stored in audio buffers in block 314. Speech that is extracted is provided to block 316 for a speech to text conversion resulting in text being stored in the text buffer and block 318.

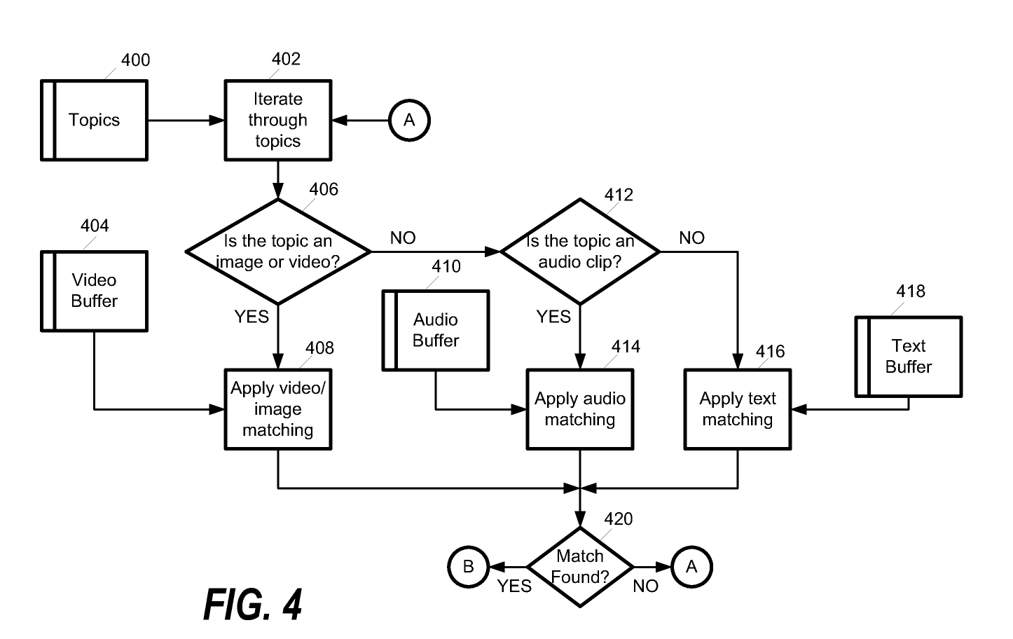

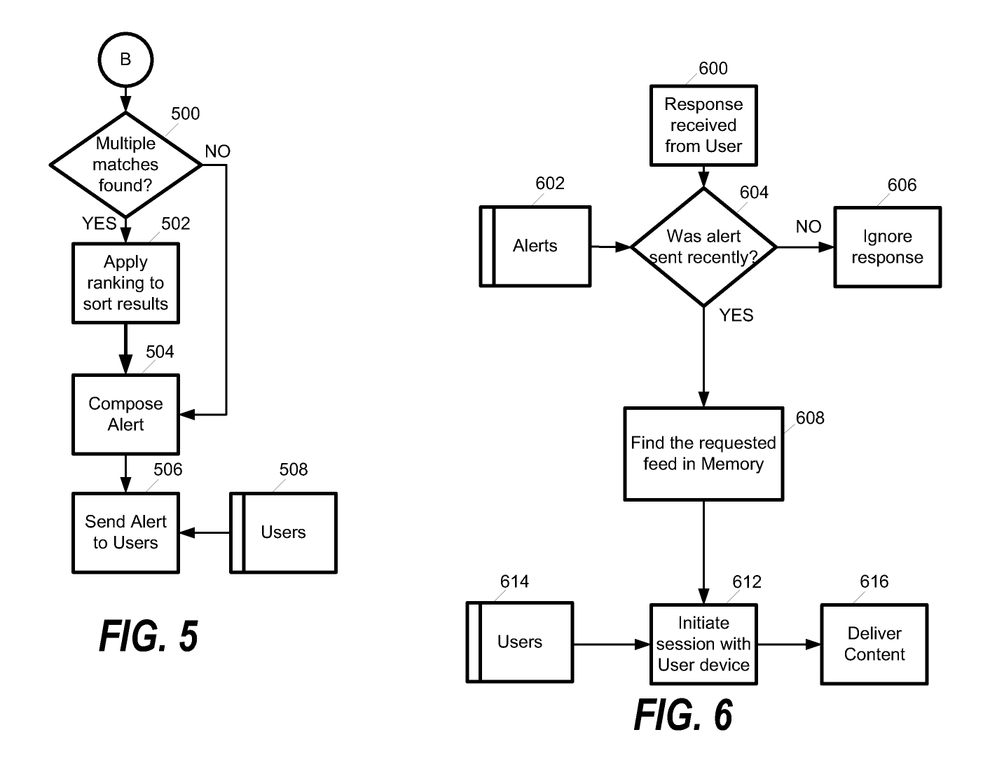

In FIG. 4 is a flowchart of the analysis process. In block 402, the program iterates through the stored topics in memory 400. These are the user topics that have been previously provided by the user. In decision module 406, the program determines whether the topic is an image or a video. If neither, in decision module 412, the program determines whether the topic is an audio segment. If not, in block 416 the program determines if the topic is text and, if so, text matching is performed by comparing the user topic text in memory 400 with the stored text in the text buffer 418. Returning to decision module 412, if the topic is an audio segment then audio matching is performed in block 414 comparing the user topic audio segment from memory 400 with the audio stored in buffer 410. Returning to the decision module 406, if the topic is either an image or a video segment, the video segment and image are matched with the stored data in the video and image buffer 404 in block 408. Block 408 for video and image matching, block 414 for the audio matching, and block 416 for text matching provide an indication to the decision module 420 whether or not a match was found. If no match was found, the program returns through connector A to block 402. If a match is found, the program proceeds through connector B to the flowchart of FIG. 5.

In FIG. 5, in decision module 500, the program determines whether multiple matches have occurred. If so, in block 502, the ranking of the matches is performed in order to determine the order in which alerts are to be issued. Then in block 504, the alert(s) is/are composed. The composing of the alert is also performed if only a single match occurs in decision module 500. The alert is then sent to the user in block 506 using the contact information previously stored in a user buffer 508.

Upon receiving an alert, the user can provide a response which invokes a process illustrated in the flowchart of FIG. 6. In block 600, the program receives the user response. In decision module 604, the alerts stored in buffer 602 are examined to determine if the response is to a recent alert. If not, the response is ignored in block 606. This feature of the preferred embodiment is provided since the storage capacity of content storage is limited. In other words, if the user waits a long time period to ask for the content, the likelihood is that the content will have been overwritten. In an alternative to the function of block 606, the user can also be contacted and told that the alert has expired. However, if the alert is recent, then, in block 608, the program finds the requested feed in Memory to be provided to the user. In block 612, a communication session is initiated by the content delivery module 126 with the user device 136 using the contact information stored in the user buffer 614 and then the content is delivered to the user device 136 in block 616 in the user designated transmission format by streaming it from the respective feed in memory.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
monitoring a plurality of continuously transmitted content channels, each providing video information and audio information, or a combination thereof with text information;
simultaneously converting the monitored content from each channel to provide data stream feeds for each of these channels;
simultaneously analyzing each channel feed to determine if a user provided topic is included in any of these feeds; and
sending an alert to the user when a channel feed includes a user provided topic.

2. The method of claim 1 further comprising receiving a request from the user in response to the alert, requesting continuously transmitted content from the channel having the user provided topic.

3. The method of claim 2 further comprising providing the requested content in the user designated transmission format.

4. The method of claim 1 wherein the transmitted channel content further includes text information and the user provided topic comprises specific text information, video segment information, audio segment information or image information.

5. The method according to claim 4 wherein the user provided topic further comprises a specification of spoken languages.

6. The method according to claim 4 wherein the user provided topic further comprises a plurality of topics and a ranking for each of the plurality of topics designating the order in which the user desires to receive the alerts if multiple alerts occur simultaneously.

7. The method according to claim 4 wherein the user provided topic further comprises a user specified geographic area where the user is to be located to receive alerts.

8. A data processing system comprising:
a monitor connected to a plurality of continuously transmitted content channels, wherein each channel providing video information and audio information, or a combination thereof with text information; the monitor including a plurality of channel converters, each converter connected to an individual channel and each channel converter simultaneously converting its channel content into a data stream feed for that channel;
a plurality of content analyzers, each analyzer connected to a unique channel converter to receive the channel data feed and including a user topic recognition circuit providing a match signal upon matching a user topic with information contained in the channel data feed; and
an alert circuit connected to each of the content analyzers and providing an alert signal to a user designating a channel when one of the content analyzers provides a match signal.

9. A system according to claim 8 further comprising a request receiving circuit connected to the monitor and the alert circuit to receive a request from the user to transmit content of the designated channel to the user.

10. A system according to claim 9 wherein the request receiving circuit further includes a circuit to transmit the designated channel to the user in the user designated transmission format.

11. A system according to claim 8 further comprising a user designation input circuit connected to the plurality of content analyzers and user topic recognition circuit to receive a user designated topic of either text information, video segment information, audio segment information or image information.

12. A system according to claim 11 wherein said user designation input circuit further receives a specification of a spoken language.

13. A system according to claim 11 wherein the user designation input circuit further receives a plurality of topics and a ranking for each of the plurality of topics designating the order in which the user desires to receive the alerts if multiple alerts occur simultaneously and further comprises user ranking circuitry for providing ranked multiple alerts in accordance with the received ranking.

14. A system according to claim 11 further including a location circuit for determining the location of the user and for further receiving a user specified geographic area where the user is to be located to receive alerts, the location circuit connected to the user designation input circuit for providing the alerts to the user only when the user is in the user specified geographic area.

15. A computer program product for monitoring and analyzing transmitted content channels, said computer program product comprising:
a computer readable storage medium;
first program instruction to monitor a plurality of continuously transmitted content channels, each providing video information and audio information, or a combination thereof with text information;
second program instructions to simultaneously convert the monitored content from each channel to provide data stream feeds for each of these channels;
third program instruction to simultaneously analyze each channel feed to determine if a user provided topic is included in any of these feeds; and
fourth program instructions to send an alert to the user when a channel feed includes a user provided topic; and
wherein said first, second, third and fourth program instructions are stored on said computer readable storage medium.

16. The computer program according to claim 15 further comprising fifth program instructions to receive a request from the user in response to the alert requesting continuously transmitted content from the channel having the user provided topic.

17. The computer program according to claim 16 wherein the fifth program instructions further comprise program instructions to provide the channel content in the user designated transmission format.

18. The computer program according to claim 16 wherein the user provided topic comprises specific text information, video segment information, audio segment information or image information.

19. The computer program according to claim 16 wherein the user provided topic further comprises a plurality of topics and a ranking for each of the plurality of topics designating the order in which the user desires to receive the alerts if multiple alerts occur simultaneously.

20. The computer program according to claim 16 wherein the user provided topic further comprises a user specified geographic area where the user is to be located to receive alerts and the fifth program instructions further comprise program instructions for determining a user current location and for determining if the user current location is within the user specified geographic area.
